(19) United States
(12) Patent Application Publication
(10) Pub. No.: US 2008/0293589 A1
(43) Pub. Date: Nov. 27, 2008

(54) Multiplex locus specific amplification

(75) Inventor: Michael H. Shapero, Redwood City, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: Affymetrix, Inc., Santa Clara, CA (US)

(21) Appl. No.: 12/127,770

(22) Filed: May 27, 2008

Related U.S. Application Data
(60) Provisional application No. 60/940,067, filed on May 24, 2007.

(51) Int. Cl. C40B 30/04

(52) U.S. Cl. 506/9

(57) ABSTRACT

Methods are provided for amplifying a plurality of pre-selected target sequences from a complex background of nucleic acids. The targets are selected for amplification using splint oligonucleotides that are used to modify the ends of the fragments. The fragments have known end sequences and the splints are designed to be complementary to the ends. In one aspect the splint brings the ends of the fragment together and the ends are joined to form a circle. In another aspect the splint is used to add a common priming site to the ends of the target fragments. Specific loci are amplified and can be subsequently analyzed.

### RELATED APPLICATIONS

This application claims priority to U.S. Provisional Application No. 60/940,067 filed May 24, 2007, which is incorporated herein in its entirety for all purposes.

### FIELD OF THE INVENTION

The methods of the invention relate generally to amplification of a template DNA sample and analysis of the amplified sample.

### BACKGROUND OF THE INVENTION

The past years have seen a dynamic change in the ability of science to comprehend vast amounts of data. Pioneering technologies such as nucleic acid arrays allow scientists to delve into the world of genetics in far greater detail than ever before. Exploration of genomic DNA has long been a dream of the scientific community. Held within the complex structures of genomic DNA lies the potential to identify, diagnose, or treat diseases like cancer, Alzheimer disease or alcoholism.

New techniques such as multiple strand displacement (mda) amplification based on highly processive enzymes have allowed new types of experiments to be conducted when only limiting amounts of genomic DNA samples are available. However, there are applications where it would be beneficial to amplify a certain segment of the genome rather than amplifying the entire genome. This invention discloses a method using locus-specific primers, DNA polymerases, and endonucleases for long-range amplification.

### SUMMARY OF THE INVENTION

Methods for amplifying a plurality of target sequences from a nucleic acid sample and analyzing the amplified target sequences. The method includes the steps of (a) fragmenting the nucleic acid sample with at least one restriction enzyme to generate fragments with known sequences at the 5′ fragment end and the 3′ fragment end, wherein at least some of the fragments are target fragments; (b) mixing the fragments obtained in (a) with a plurality of target specific splint oligonucleotides, wherein each splint oligonucleotide comprises a first sequence that is at least 10 bases in length and is perfectly complementary to the at least 10 bases at the 5′ end of a corresponding target fragment, and a second sequence that is at least 10 bases in length and is perfectly complementary to the at least 10 bases at and including the 3′ end of the corresponding target fragment, and wherein the first sequence is 5′ of the second sequence in the splint oligonucleotide, wherein target specific splint oligonucleotides hybridize to corresponding target fragments so that the 5′ and 3′ ends of the hybridized target fragments are brought into proximity of one another; (c) ligating the ends of the hybridized target fragments to obtain circularized target fragments; (d) separating the circularized target fragments from splint oligonucleotides and uncircularized fragments; (e) amplifying the circular target fragments to obtain amplified target sequences; and (f) analyzing the amplified target sequences using an array comprising a plurality of oligonucleotide probes present at known or determinable locations in the array.

In another aspect methods for amplifying and analyzing a plurality of target sequences from a nucleic acid sample are disclosed. The method includes the steps of (a) fragmenting the nucleic acid sample with a restriction enzyme to obtain fragments with known sequences at the 5′ and 3′ ends of the fragments, wherein the fragments comprise a plurality of target fragments comprising target sequences; (b) mixing the fragments obtained in (a) with a plurality of target specific splint oligonucleotides, wherein each splint oligonucleotide comprises a first target complementary sequence that is at least 10 bases in length and is perfectly complementary to the at least 10 bases at the 3′ end of a corresponding target fragment, and a second target complementary sequence that is at least 10 bases in length and is perfectly complementary to the at least 10 bases at and including the 5′ end of the corresponding target fragment, and wherein the first sequence is 5′ of the second sequence in the splint oligonucleotide, wherein target specific splint oligonucleotides further comprises a first common priming sequence at the 5′ end and a second common priming sequence at the 3′ end; (c) adding first and second primers to the mixture wherein the first primer is complementary to the first common priming sequence and the second primer is complementary to the second common priming sequence and wherein the first and second primers hybridize to the splint oligonucleotides so the first primer is adjacent to the 3′ end of the target fragment and the second primer is adjacent to the 5′ end of the target fragment; (d) ligating the first primer to the 3′ end of the target fragment and the second primer to the 5′ end of the target fragment to obtain ligated target fragments comprising a first common priming site at the 3′ end and a second common priming sites at the 5′ end; (e) after the ligating step (d) fragmenting the splint oligonucleotides; (f) amplifying the ligated target fragments from (d) to obtain amplified target fragments; and (g) analyzing the amplified target fragments by a method comprising hybridization to an array comprising a plurality of oligonucleotide probes present at known or determinable locations in the array.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a method for selecting target circles and amplifying the selected circles.

FIG. 2A shows the use of a splint to add common primers to target sequences.

FIG. 2B shows amplification of the products generated in FIG. 2A using a nicking enzyme and a strand displacing polymerase.

FIG. 3 shows splint mediated circularization and amplification.

FIG. 4 shows splint mediated amplification with introduction of tag sequences.

FIG. 5 shows a method for detection of inversion using splint mediated amplification.

FIG. 6 shows detection of CNP using splint mediated amplification.

FIG. 7 shows results of quantitative PCR assay.

FIG. 8 shows results of the splint titration.

FIG. 9 shows results of genotyping using amplified, unamplified circles and genomic DNA for a SNP.

### DETAILED DESCRIPTION OF THE INVENTION

### a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, N.Y., Gait, “Oligonucleotide Synthesis: A Practical Approach” 1984, IRL Press, London, Nelson and Cox (2000), Lehninger, Principles of Biochemistry 3^{rd} Ed., W. H. Freeman Pub., New York, N.Y. and Berg et al. (2002) Biochemistry, 5^{th} Ed., W. H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication Number WO 99/36760) and PCT/US01/04285, which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GENECHIP®. Example arrays are shown on the website at affymetrix.com.

The present invention also contemplates many uses for polymers attached to solid substrates. These uses include gene expression monitoring, profiling, library screening, genotyping and diagnostics. Gene expression monitoring, and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 60/319,253, 10/013,598, and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909, 5,861,245) and nucleic acid based sequence amplification (NABSA). (See, U.S. Pat. Nos. 5,409,818, 5,554,517, and 6,063,603 each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491, 09/910,292, and 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2^{nd} Ed. Cold Spring Harbor, N.Y., 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference.

The present invention also contemplates signal detection of hybridization between ligands in certain preferred embodiments. See U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,225,625, in U.S. Ser. No. 60/364,731 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. No. 60/364,731 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd} ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/063,559 (United States Publication No. US20020183936), 60/349,546, 60/376,003, 60/394,574 and 60/403,381.

### b) Definitions

“Adaptor sequences” or “adaptors” are generally oligonucleotides of at least 5, 10, or 15 bases and preferably no more than 50 or 60 bases in length; however, they may be even longer, up to 100 or 200 bases. Adaptor sequences may be synthesized using any methods known to those of skill in the art. For the purposes of this invention they may, as options, comprise primer binding sites, recognition sites for endonucleases, common sequences and promoters. The adaptor may be entirely or substantially double stranded or entirely single stranded. A double stranded adaptor may comprise two oligonucleotides that are at least partially complementary. The adaptor may be phosphorylated or unphosphorylated on one or both strands.

Adaptors may be more efficiently ligated to fragments if they comprise a substantially double stranded region and a short single stranded region which is complementary to the single stranded region created by digestion with a restriction enzyme. For example, when DNA is digested with the restriction enzyme EcoRI the resulting double stranded fragments are flanked at either end by the single stranded overhang 5′-AATT-3′, an adaptor that carries a single stranded overhang 5′-AATT-3′ will hybridize to the fragment through complementarity between the overhanging regions. This “sticky end” hybridization of the adaptor to the fragment may facilitate ligation of the adaptor to the fragment but blunt ended ligation is also possible. Blunt ends can be converted to sticky ends using the exonuclease activity of the Klenow fragment. For example when DNA is digested with PvuII the blunt ends can be converted to a two base pair overhang by incubating the fragments with Klenow in the presence of dTTP and dCTP. Overhangs may also be converted to blunt ends by filling in an overhang or removing an overhang.

Methods of ligation will be known to those of skill in the art and are described, for example in Sambrook et al. (2001) and the New England BioLabs catalog both of which are incorporated herein by reference for all purposes. Methods include using T4 DNA Ligase which catalyzes the formation of a phosphodiester bond between juxtaposed 5′ phosphate and 3′ hydroxyl termini in duplex DNA or RNA with blunt and sticky ends; Taq DNA Ligase which catalyzes the formation of a phosphodiester bond between juxtaposed 5′ phosphate and 3′ hydroxyl termini of two adjacent oligonucleotides which are hybridized to a complementary target DNA; E. coli DNA ligase which catalyzes the formation of a phosphodiester bond between juxtaposed 5′-phosphate and 3′-hydroxyl termini in duplex DNA containing cohesive ends; and T4 RNA ligase which catalyzes ligation of a 5′ phosphoryl-terminated nucleic acid donor to a 3′ hydroxyl-terminated nucleic acid acceptor through the formation of a 3′→5′ phosphodiester bond, substrates include single-stranded RNA and DNA as well as dinucleoside pyrophosphates; or any other methods described in the art. Fragmented DNA may be treated with one or more enzymes, for example, an endonuclease, prior to ligation of adaptors to one or both ends to facilitate ligation by generating ends that are compatible with ligation.

Adaptors may also incorporate modified nucleotides that modify the properties of the adaptor sequence. For example, phosphorothioate groups may be incorporated in one of the adaptor strands. A phosphorothioate group is a modified phosphate group with one of the oxygen atoms replaced by a sulfur atom. In a phosphorothioated oligo (often called and “S-Oligo”), some or all of the internucleotide phosphate groups are replaced by phosphorothioate groups. The Modified backbone of an S-Oligo is resistant to the action of most exonucleases and endonucleases. Phosphorothioates may be incorporated between all residues of an adaptor strand, or at specified locations within a sequences. A useful option is to sulfurize only the last few residues at each end of the oligo. This results in an oligo that is resistant to exonucleases, but has a natural DNA center.

The term “array” as used herein refers to an intentionally created collection of molecules which can be prepared either synthetically or biosynthetically. The molecules in the array can be identical or different from each other. The array can assume a variety of formats, for example, libraries of soluble molecules; libraries of compounds tethered to resin beads, silica chips, or other solid supports.

The term “array plate” as used herein refers to a body having a plurality of arrays in which each microarray is separated by a physical barrier resistant to the passage of liquids and forming an area or space, referred to as a well, capable of containing liquids in contact with the probe array.

The term “complementary” as used herein refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

The term “epigenetic” as used herein refers to factors other than the primary sequence of the genome that affect the development or function of an organism, they can affect the phenotype of an organism without changing the genotype. Epigenetic factors include modifications in gene expression that are controlled by heritable but potentially reversible changes in DNA methylation and chromatin structure. Methylation patterns are known to correlate with gene expression and in general highly methylated sequences are poorly expressed.

The term “genome” as used herein is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

The term “hybridization” as used herein refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” Hybridizations are usually performed under stringent conditions, for example, at a salt concentration of no more than about 1 M and a temperature of at least 25° C. For example, conditions of 5×SSPE (750 mM NaCl, 50 mM NaPhosphate, 5 mM EDTA, pH 7.4) and a temperature of 25° C.-30° C. are suitable for allele-specific probe hybridizations or conditions of 100 mM MES, 1 M [Na⁺], 20 mM EDTA, 0.01% Tween-20 and a temperature of 30° C.-50° C., preferably at about 45° C.-50° C. Hybridizations may be performed in the presence of agents such as herring sperm DNA at about 0.1 mg/ml, acetylated BSA at about 0.5 mg/ml. As other factors may affect the stringency of hybridization, including base composition and length of the complementary strands, presence of organic solvents and extent of base mismatching, the combination of parameters is more important than the absolute measure of any one alone. Hybridization conditions suitable for microarrays are described in the Gene Expression Technical Manual, 2004 and the GeneChip Mapping Assay Manual, 2004, available at Affymetrix.com.

The term “hybridization probes” as used herein are oligonucleotides capable of binding in a base-specific manner to a complementary strand of nucleic acid. Such probes include peptide nucleic acids, as described in Nielsen et al., Science 254, 1497-1500 (1991), LNAs, as described in Koshkin et al. Tetrahedron 54:3607-3630, 1998, and U.S. Pat. No. 6,268,490 and other nucleic acid analogs and nucleic acid mimetics.

The term “isolated nucleic acid” as used herein mean an object species invention that is the predominant species present (i.e., on a molar basis it is more abundant than any other individual species in the composition). Preferably, an isolated nucleic acid comprises at least about 50%, 80% or 90% (on a molar basis) of all macromolecular species present. Most preferably, the object species is purified to essential homogeneity (contaminant species cannot be detected in the composition by conventional detection methods).

The term “label” as used herein refers to a luminescent label, a light scattering label or a radioactive label. Fluorescent labels include, inter alia, the commercially available fluorescein phosphoramidites such as Fluoreprime (Pharmacia), Fluoredite (Millipore) and FAM (ABI). See U.S. Pat. No. 6,287,778.

The term “ligand” as used herein refers to a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (for example, opiates, steroids, etc.), hormone receptors, peptides, enzymes, enzyme substrates, substrate analogs, transition state analogs, cofactors, drugs, proteins, and antibodies.

Linkage disequilibrium or allelic association means the preferential association of a particular allele or genetic marker with a specific allele, or genetic marker at a nearby chromosomal location more frequently than expected by chance for any particular allele frequency in the population. For example, if locus X has alleles a and b, which occur equally frequently, and linked locus Y has alleles c and d, which occur equally frequently, one would expect the combination ac to occur with a frequency of 0.25. If ac occurs more frequently, then alleles a and c are in linkage disequilibrium. Linkage disequilibrium may result from natural selection of certain combination of alleles or because an allele has been introduced into a population too recently to have reached equilibrium with linked alleles.

The term “mixed population” or sometimes refer by “complex population” as used herein refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but includes other undesirable populations. For example, a complex population of nucleic acids may be a sample which has been enriched for desired messenger RNA (mRNA) sequences but still includes some undesired ribosomal RNA sequences (rRNA).

The term “mRNA” or sometimes refer by “mRNA transcripts” as used herein, include, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

The term “nucleic acid library” as used herein refers to an intentionally created collection of nucleic acids which can be prepared either synthetically or biosynthetically and screened for biological activity in a variety of different formats (for example, libraries of soluble molecules; and libraries of oligos tethered to beads, chips, or other solid supports). Additionally, the term “array” is meant to include those libraries of nucleic acids which can be prepared by spotting nucleic acids of essentially any length (for example, from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

The term “nucleic acids” as used herein may include any polymer or oligomer of pyrimidine and purine bases, preferably cytosine, thymine, and uracil, and adenine and guanine, respectively. See Albert L. Lehninger, PRINCIPLES OF BIOCHEMISTRY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

The term “oligonucleotide+ or sometimes refer by “polynucleotide” as used herein refers to a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

Polymorphism refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 5%, 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. Single nucleotide polymorphisms (SNPs) are included in polymorphisms.

The term “primer” as used herein refers to a single-stranded oligonucleotide capable of acting as a point of initiation for template-directed DNA synthesis under suitable conditions for example, buffer and temperature, in the presence of four different nucleoside triphosphates and an agent for polymerization, such as, for example, DNA or RNA polymerase or reverse transcriptase. The length of the primer, in any given case, depends on, for example, the intended use of the primer, and generally ranges from 15 to 30 nucleotides. Short primer molecules generally require cooler temperatures to form sufficiently stable hybrid complexes with the template. A primer need not reflect the exact sequence of the template but must be sufficiently complementary to hybridize with such template. The primer site is the area of the template to which a primer hybridizes. The primer pair is a set of primers including a 5′ upstream primer that hybridizes with the 5′ end of the sequence to be amplified and a 3′ downstream primer that hybridizes with the complement of the 3′ end of the sequence to be amplified.

The term “probe” as used herein refers to a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (for example, opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

The term “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term target is used herein, no difference in meaning is intended. A “Probe Target Pair” is formed when two macromolecules have combined through molecular recognition to form a complex.

The term “wafer” as used herein refers to a substrate having surface to which a plurality of arrays are bound. In a preferred embodiment, the arrays are synthesized on the surface of the substrate to create multiple arrays that are physically separate. In one preferred embodiment of a wafer, the arrays are physically separated by a distance of at least about 0.1, 0.25, 0.5, 1 or 1.5 millimeters. The arrays that are on the wafer may be identical, each one may be different, or there may be some combination thereof. Particularly preferred wafers are about 8″×8″ and are made using the photolithographic process.

The term “isothermal amplification” refers to an amplification reaction that is conducted at a substantially constant temperature. The isothermal portion of the reaction may be proceeded by or followed by one or more steps at a variable temperature, for example, a first denaturation step and a final heat inactivation step or cooling step. It will be understood that this definition by no means excludes certain, preferably small, variations in temperature but is rather used to differentiate the isothermal amplification techniques from other amplification techniques known in the art that basically rely on “cycling temperatures” in order to generate the amplified products. Isothermal amplification, varies from, for example PCR, in that PCR amplification relies on cycles of denaturation by heating followed by primer hybridization and polymerization at a lower temperature.

The term “Strand Displacement Amplification” (SDA) is an isothermal in vitro method for amplification of nucleic acid. In general, SDA methods initiate synthesis of a copy of a nucleic acid at a free 3′ OH that may be provided, for example, by a primer that is hybridized to the template. The DNA polymerase extends from the free 3′ OH and in so doing, displaces the strand that is hybridized to the template leaving a newly synthesized strand in its place. Subsequent rounds of amplification can be primed by a new primer that hybridizes 5′ of the original primer or by introduction of a nick in the original primer. Repeated nicking and extension with continuous displacement of new DNA strands results in exponential amplification of the original template. Methods of SDA have been previously disclosed, including use of nicking by a restriction enzyme where the template strand is resistant to cleavage as a result of hemimethylation. Another method of performing SDA involves the use of “nicking” restriction enzymes that are modified to cleave only one strand at the enzymes recognition site. A number of nicking restriction enzymes are commercially available from New England Biolabs and other commercial vendors.

Polymerases useful for SDA generally will initiate 5′ to 3′ polymerization at a nick site, will have strand displacing activity, and preferably will lack substantial 5′ to 3′ exonuclease activity. Enzymes that may be used include, for example, the Klenow fragment of DNA polymerase I, Bst polymerase large fragment, Phi29, and others. DNA Polymerase I Large (Klenow) Fragment consists of a single polypeptide chain (68 kDa) that lacks the 5′ to 3′ exonuclease activity of intact E. coli DNA polymerase I. However, DNA Polymerase I Large (Klenow) Fragment retains its 5′ to 3′ polymerase, 3′ to 5′ exonuclease and strand displacement activities. The Klenow fragment has been used for SDA. For methods of using Klenow for SDA see, for example, U.S. Pat. Nos. 6,379,888; 6,054,279; 5,919,630; 5,856,145; 5,846,726; 5,800,989; 5,766,852; 5,744,31 1; 5,736,365; 5,712,124; 5,702,926; 5,648,21 1;5,641,633; 5,624,825; 5,593,867; 5,561,044; 5,550,025; 5,547,861; 5,536,649; 5,470,723; 5,455,166; 5,422,252; 5,270,184, the disclosures of which are incorporated herein by reference. Examples of other enzymes that may be used include: exo minus Vent (NEB), exo minus Deep Vent (NEB), Bst (BioRad), exo minus Pfu (Stratagene), Pfx (Invitrogen), 9°Nₘ™ (NEB), and other thermostable polymerases.

Phi29 is a DNA polymerase from Bacillus subtilis that is capable of extending a primer over a very long range, for example, more than 10 Kb and up to about 70 Kb. This enzyme catalyzes a highly processive DNA synthesis coupled to strand displacement and possesses an inherent 3′ to 5′ exonuclease activity, acting on both double and single stranded DNA. Variants of phi29 enzymes may be used, for example, an exonuclease minus variant may be used. Phi29 DNA Polymerase optimal temperature range is between about 30° C. to 37° C., but the enzyme will also function at higher temperatures and may be inactivated by incubation at about 65° C. for about 10 minutes. Phi29 DNA polymerase and Tma Endonuclease V (available from Fermentas Life Sciences) are active under compatible buffer conditions. Phi29 is 90% active in NEBuffer 4 (20 mM Tris-acetate, 50 mM potassium acetate, 10 mM magnesium acetate and 1 mM DTT, pH 7.9 at 25° C.) and is also active in NEBuffer 1 (10 mM Bis-Tris-Propane-HCl, 10 mM magnesium chloride and 1 mM DTT, pH 7.0 at 25° C.), NEBuffer 2 (50 mM sodium chloride, 10 mM Tris-HCl, 10 mM magnesium chloride and 1 mM DTT, pH 7.9 at 25° C.), NEBuffer 3 (100 mM NaCl, 50 mM Tris HCl, 10 mM magnesium chloride and 1 mM DTT, pH 7.9 at 25° C.). For additional information on phi29, see U.S. Pat. Nos. 5,100,050, 5,198,543 and 5,576,204.

Bst DNA polymerase originates from Bacillus stearothermophilus and has a 5′ to 3′ polymerase activity, but lacks a 5′ to 3′ exonuclease activity. This polymerase is known to have strand displacing activity. The enzyme is available from, for example, New England Biolabs. Bst is active at high temperatures and the reaction may be incubated optimally at about 65° C. but also retains 30%-45% of its activity at 50° C. Its active range is between 37° C.-80° C. The enzyme tolerates reaction conditions of 70° C. and below and can be heat inactivated by incubation at 80° C. for 10 minutes. Bst DNA polymerase is active in the NEBuffer 4 (20 mM Tris-acetate, 50 mM potassium acetate, 10 mM magnesium acetate and 1 mM DTT, pH 7.9 at 25° C.) as well as NEBuffer 1 (10 mM Bis-Tris-Propane-HCl, 10 mM magnesium chloride and 1 mM DTT, pH 7.0 at 25° C.), NEBuffer 2 (50 mM sodium chloride, 10 mM Tris-HCl, 10 mM magnesium chloride and 1 mM DTT, pH 7.9 at 25° C.), and NEBuffer 3 (100 mM NaCl, 50 mM Tris HCl, 10 mM magnesium chloride and 1 mM DTT, pH 7.9 at 25° C.). Bst DNA polymerase could be used in conjunction with E. coli Endonuclease V (available from New England Biolabs). For additional information see Mead, D. A. et al. (1991) BioTechniques, p.p. 76-87, McClary, J. et al. (1991) J. DNA Sequencing and Mapping, p.p. 173-180 and Hugh, G. and Griffin, M. (1994) PCR Technology, p.p. 228-229.

The term “endonuclease” refers to an enzyme that cleaves a nucleic acid (DNA or RNA) at internal sites in a nucleotide base sequence. Cleavage may be at a specific recognition sequence, at sites of modification or randomly. Specifically, their biochemical activity is the hydrolysis of the phosphodiester backbone at sites in a DNA sequence. Examples of endonucleases include Endonuclease V (Endo V) also called deoxyinosine 3′ endonuclease, which recognizes DNA containing deoxyinosines (paired or not). Endonuclease V cleaves the second and third phosphodiester bonds 3′ to the mismatch of deoxyinosine with a 95% efficiency for the second bond and a 5% efficiency for the third bond, leaving a nick with 3′ hydroxyl and 5′ phosphate. Endo V, to a lesser, degree, also recognizes DNA containing abasic sites and also DNA containing urea residues, base mismatches, insertion/deletion mismatches, hairpin or unpaired loops, flaps and pseudo-Y structures. See also, Yao et al., J. Biol. Chem., 271(48): 30672 (1996), Yao et al., J. Biol. Chem., 270(48): 28609 (1995), Yao et al., J. Biol. Chem., 269(50): 31390 (1994), and He et al., Mutat. Res., 459(2):109 (2000). Endo V from E. coli is active at temperatures between about 30 and 50° C. and preferably is incubated at a temperature between about 30° C. to 37° C. Endo V is active in NEBuffer 4 (20 mM Tris-acetate, 50 mM potassium acetate, 10 mM magnesium acetate and 1 mM DTT, pH 7.9 at 25° C.), but is also active in other buffer conditions, for example, 20 mM HEPES-NaOH (pH 7.4), 100 mM KCl, 2 mM MnCl₂ and 0.1 mg/ml BSA. Endo V makes a strand specific nick about 2-3 nucleotides downstream of the 3′ side of inosine base, without removing the inosine base. Endonucleases, including Endo V, may be obtained from manufacturers such as New England Biolabs (NEB) or Fermentas Life Sciences.

The RecA protein is a protein found in E. coli that in the presence of ATP, promotes the strand exchange of single-strand DNA fragments with homologous duplex DNA. RecA is also an ATPase, an enzyme capable of hydrolyzing ATP, when bound to DNA. RecA uses ATP to carry out strand exchange over long sequences and impose direction to the exchange, to bypass short sequence heterogeneities, and to stall replication so DNA lesions can be mended. The reaction has three distinct steps: (i) RecA polymerizes on the single-strand DNA to form a nucleoprotein filament, (ii) the nucleoprotein filament binds the duplex DNA and searches for a homologous region in a process that requires ATP but not hydrolysis, because ATPγS, a noncleavable analogue, can substitute, (iii) RecA catalyzes local denaturation of the duplex and strand exchange with the single-stranded DNA, see also Radding, C. M. (1991) J. Biol. Chem., 266: 5355-5358. Recombinant E.coli RecA is commercially available from, for example, New England Biolabs. The use of a nonhydrolyzable analogue such as ATPγS favors the formation of stable triple stranded complexes. For reaction conditions useful for promoting oligonucleotide binding to a duplex DNA, see Rigas et al. Proc. Natl. Acad. Sci. USA 83:9591-9595 (1986) and Honigberg et al. Proc. Natl. Acad. Sci. USA 83:9586-9590 (1986). RecA is active under a variety of reaction conditions and can be heat inactivated at 65° C. for 20 minutes.

### c) Isothermal Locus-Specific Amplification

The invention provides methods and compositions for polynucleotide amplification of a plurality of selected target sequences of interest, as well as applications of the amplification methods. Nucleic acid amplification has extensive applications in gene expression profiling, genetic testing, diagnostics, environmental monitoring, resequencing, forensics, drug discovery, pharmacogenomics and other areas. Nucleic acid samples may be derived, for example, from total nucleic acid from a cell or sample, total RNA, cDNA, genomic DNA or mRNA. Many methods of analysis of nucleic acid employ methods of amplification of the nucleic acid sample prior to analysis. A number of methods for the amplification of nucleic acids have been described, for example, exponential amplification, linked linear amplification, ligation-based amplification, and transcription-based amplification. An example of exponential nucleic acid amplification method is polymerase chain reaction (PCR) which has been disclosed in numerous publications. See, for example, Mullis et al. Cold Spring Harbor Symp. Quant. Biol. 51:263-273 (1986); and U.S. Pat. Nos. 4,582,788 and 4,683,194.

Nucleic acid amplification may be carried out through multiple cycles of incubations at various temperatures, i.e. thermal cycling or PCR, or at a constant temperature (an isothermal process). An example of an isothermal amplification technique involves a single, elevated temperature using a DNA polymerase that contains the 5′ to 3′ polymerase activity but lacks the 5′ to 3′ exonuclease activity. As the new strand of DNA is synthesized from the template strand of DNA, the complementary strand of the DNA target is displaced from the original DNA helix. The use of specific primers that invade the target DNA strand allows for self-sustaining amplification and detection techniques and can detect very low copy targets. Isothermal amplification methods, such as strand displacement amplification (SDA), are disclosed in U.S. Pat. Nos. 5,648,211, 5,824,517, 6,858,413, 6,692,918, 6,686,156, 6,251,639 and 5,744,311 and U.S. Patent Pub. No. 20040115644 and in Walker et al. Proc. Natl. Acad. Sci. U.S.A. 89: 392-396 (1992); Guatelli, J. C. et al. Proc. Natl. Acad. Sci. USA 87:1874-1878 (1990); which are incorporated herein by reference in their entirety.

When a pair of amplification primers is used, each of which hybridizes to one of the two strands of a double stranded target sequence, amplification is exponential. This is because the newly synthesized strands serve as templates for the opposite primer in subsequent rounds of amplification. When a single amplification primer is used, amplification is linear because only one strand serves as a template for primer extension and newly synthesized strands are not used as template. Amplification methods that proceed linearly during the course of the amplification reaction are less likely to introduce bias in the relative levels of different mRNAs than those that proceed exponentially. “Single-primer amplification” protocols have been reported in many patents (see, for example, U.S. Pat. Nos. 5,554,516, 5,716,785, 6,132,997, 6,251,639, and 6,692,918 which are incorporated herein by reference in their entirety).

Nucleic acid amplification techniques may be grouped according to the temperature requirements of the procedure. Certain nucleic acid amplification methods, such as the polymerase chain reaction (PCR, Saiki et al., Science, 230:1350-1354, 1985), ligase chain reaction (LCR, Wu et al., Genomics, 4:560-569, 1989; Barringer et al., Gene, 89:117-122,1990; Barany, Proc. Natl. Sci. USA, 88:189-193,1991), transcription-based amplification (Kwoh et al., Proc. Natl. Acad. Sci., USA, 86:1173-1177, 1989) and restriction amplification (U.S. Pat. No. 5,102,784), require temperature cycling of the reaction between high denaturing temperatures and somewhat lower polymerization temperatures. In contrast, methods such as self-sustained sequence replication (Guatelli et al., Proc. Natl. Acad. Sci. USA, 87:1874-1878, 1990), the Q.beta. replicase system (Lizardi et al., BioTechnology, 6:1197-1202, 1988), and Strand Displacement Amplification (SDA—Walker et al., Proc. Natl. Acad. Sci. USA, 89:392-396, 1992a, Walker et al., Nuc. Acids. Res., 20:1691-1696, 1992b; U.S. Pat. No. 5,455,166) are isothermal reactions that are conducted at a constant temperature, which are typically much lower than the reaction temperatures of temperature cycling amplification methods.

The Strand Displacement Amplification (SDA) reaction initially developed was conducted at a constant temperature between about 37° C. and 42° C. (U.S. Pat. No. 5,455,166). This temperature range was selected because the exo-klenow DNA polymerase and the restriction endonuclease (e.g., HindII) are mesophilic enzymes that are thermolabile (temperature sensitive) at temperatures above this range. The enzymes that drive the amplification are therefore inactivated as the reaction temperature is increased. Isothermal SDA may also be performed at higher temperatures, for example, 50° C. to 70° C. by using enzymes that are thermostable. Thermophilic SDA is described in European Patent Application No. 0 684 315 and employs thermophilic restriction endonucleases that nick the hemimodified restriction endonuclease recognition/cleavage site at high temperature and thermophilic polymerases that extend from the nick and displace the downstream strand in the same temperature range.

Attempts have been made over the years since the invention of PCR to increase the multiplex level of PCR. Some of the strategies include two-stage PCR with universal tails (Lin Z et al., PNAS 93: 2582-2587, 1996; Brownie J. et al., Nucleic Acids Res. 25: 3235-3241, 1997), solid-phase multiplex PCR (e.g., Adams and Kron, U.S. Pat. No. 5,641,658; Shapero et al., Genome Res. 11: 1926-1934, 2001), multiplexed anchored runoff amplification (MARA, Shapero et al., Nucleic Acid Res. 32: e181, 2004 and U.S. Pat. No. 7,108,976), PCR with primers designed by a special bioinformatical tool (Wang et al., Genome Res. 15: 276, 2005), selector-guided multiplex amplification (Dahl F et al., Nucleic Acids Res. 33: e71, 2005), and dU probe-based multiplex PCR after common oligo addition (Faham M and Zheng J, US patent Publication No. 20030096291 and Faham M et al., PNAS 102: 14717-14722, 2005). Multiplex PCR methods are also disclosed in U.S. Patent publication Nos. 20030104459. See also, Nilsson et al., Trends. Biotechnol. 24(2):83-8, 2006 and Stenberg et al., NAR 33(8):e72, 2005. Methods for multiplex amplification of specific groups of targets using circularization have recently been disclosed for example, in Fredriksson et al. NAR 2007, 35(7):e47 and Dahl et al., NAR 33, e71 (2005). See also, US Patent Pub. 20050037356. Each of which is incorporated herein by reference in its entirety. The current disclosure is related to provisional application Nos. 60/885,333 filed Jan. 17, 2007 and 60/887,546 filed Jan. 31, 2007 and U.S. Pat. No. 7,108,976, the entire disclosures of which are incorporated herein by reference in their entireties.

Methods for isothermal amplification using phi29 DNA polymerase and random hexamers for locus-specific amplification are disclosed. In a first embodiment, double stranded restriction fragments are circularized (self-ligated) by DNA ligase and circles are selected using a biotin-labeled capture oligo, locus-specific primers or both. In a second embodiment a capture oligonucleotide that allows ligation of primer sequences onto ends of one strand of a fragment, one primer incorporates a nicking enzyme site or a modified base such as dI or dU. In a third embodiment a splint mediates isothermal amplification.

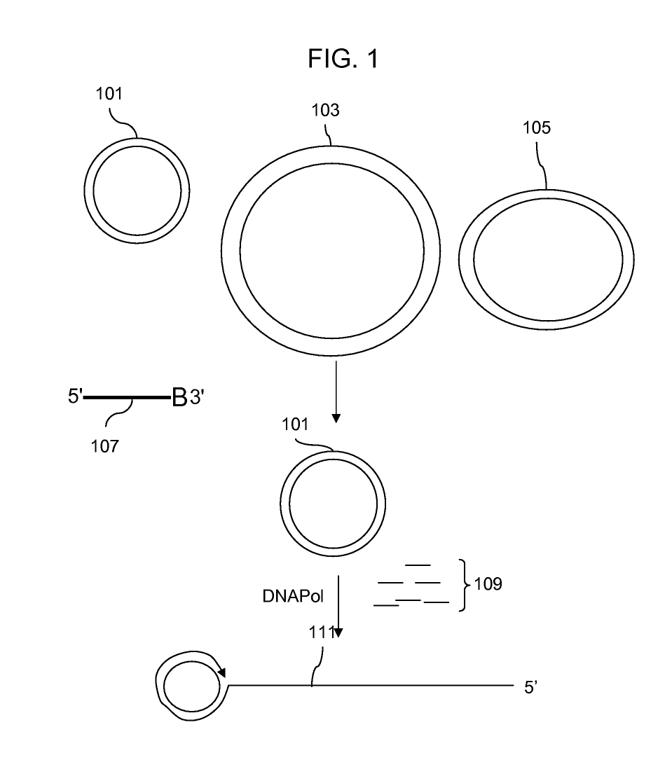

In one aspect (FIG. 1) double stranded restriction fragments are circularized by self ligation using DNA ligase. Circles are selected using a biotin-labeled capture oligo or locus-specific primers. The DNA is first fragmented by one or more enzymes and the resulting fragments are incubated with a ligase to allow circularization of the fragments. Preferably the restriction enzyme generates a single stranded overhang so that the two ends of a fragment each have a short single stranded region and the regions are complementary (sticky ends). Locus specific oligonucleotides are then added to target circles for rolling circle amplification (RCA). Only those target circles that are complementary to one of the added locus specific oligos will be amplified. Locus specific oligos can be used to capture fragments and then the enriched fraction can be amplified using random hexamers. For a description of RCA see, for example, Baner et al. (1998) NAR 26:5073, Lizardi et al. (1998) Nat. Genet. 19:225 and Fire and Xu, (1995) PNAS 92:4641-5.

The ligation may be performed using dilute DNA concentrations to favor intramolecular ligation over intermolecular ligation. T4 DNA ligase may be used to form covalently closed circular DNA molecules. Circles can be targeted for RCA using locu-specific oligos or they can be enriched for specific sequences using a capture probe followed by amplification with random hexamers.

One aspect of the method is shown schematically in FIG. 1. Following fragmentation and ligation circular DNA of different sizes is generated (101, 103 and 105). A biotin labeled oligo (107) is used to selectively capture one strand of circle 101 using streptavidin coated beads or affinity resin. Enriched circle 101 is amplified using random hexamers (109) and DNA polymerase using RCA. The amplified product 111 contains multiple copies of the sequence of 101.

In a second aspect capture oligonucleotides that allow ligation of primer sequences to the ends of one strand of a fragment are used. One primer incorporates a nicking enzyme site or a modified base, for example dI or dU.

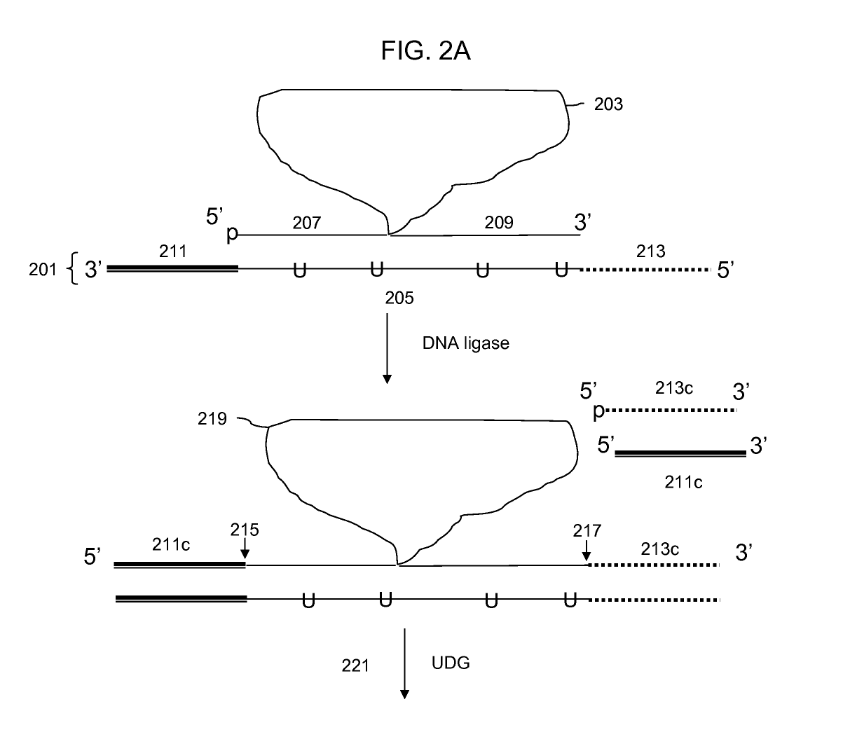

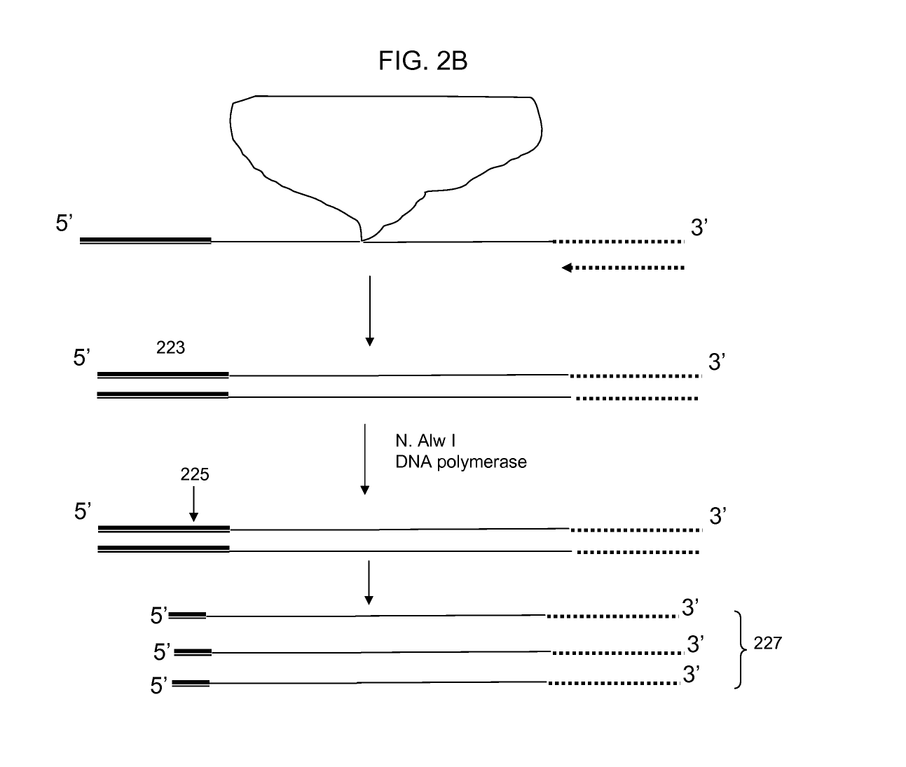

Genomic DNA is digested with a restriction enzyme such as Sau3a. One strand of the restriction fragment is captured using a capture oligonucleotide (201). The capture oligo allows the DNA strand to form a loop structure (203) in the genomic DNA target so that the ends of the fragment can be further manipulated. The capture oligo contains a target complementary sequence (205) that is complementary to the sequence generated by juxtaposition of the sequence at the 5′ end of the target fragment (207) and the sequence at the 3′ end of the target fragment (209). The capture probe is complementary to the two ends of the genomic target sequences at each end that allow ligation of known sequences to either end of the captured strand. In preferred aspects the capture probe also contains a first and a second universal priming site, one at each end of the capture probe. Shown by 211 (second) and 213 (first) in FIG. 2A. Oligos that are complementary to the universal priming site sequences of the capture probe (211c and 213c) are added and allowed to hybridize to the capture probe adjacent to the ends of the genomic DNA. The oligos can then be ligated to the ends of the target DNA (at positions indicated by 215 and 217) to obtain a genomic fragment with common priming sites at the ends (219). This adapter-ligated target fragment has the target of interest sequence flanked by common priming sites which may be amplifiable using a single primer or two different primers. The capture probe can be modified with dU or dI bases that allow it to be degraded using UDG cleavage methods (in step 221), which may include cleavage using EndoV. In some aspects a target specific tag sequence may be added between one of the priming sites and the target sequence so that the tag is subsequently amplified along with the target.

The common priming sites may then be used to amplify the entire target (including the looped out region). A primer with the sequence of 213 is used to make the adapter ligated target double stranded and copies of the top strand may be generated. In preferred aspects the ligation reaction creates a site for nicking in the common priming region 223. It may be a restriction site for a nicking enzyme such as N. Alw I, or a base such as dU or dI may be introduced. A nicking enzyme site can be added to the ligated strand. The new ligated product is converted into a double-stranded molecule by annealing primer and one round of extension (see FIG. 2B). The addition of a nicking restriction enzyme, for example N.Alw 1 and a DNA polymerase with strand displacement (SD) activity allows amplification of one strand in an isothermal manner. The nicking site is shown by the arrow at 225. Nicking occurs at 225 and the newly generated 3′ end can be extended, displacing the strand ahead of the polymerase. Alternatively E coli Endo V or Tma Endo V and DNA polymerase with SD activity may be used. Multiple copies of the displaced strand (227) are generated.

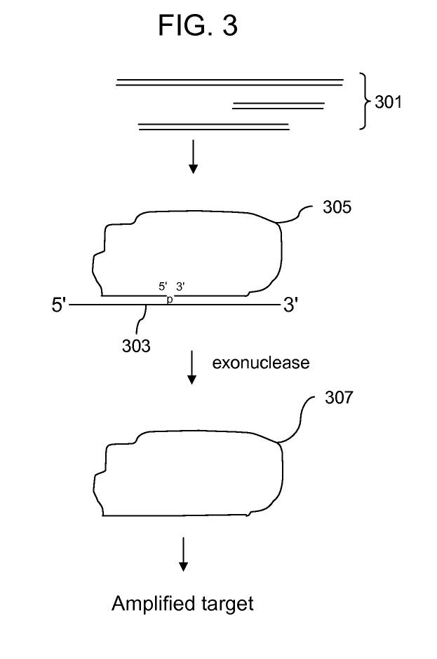

In a third embodiment Splint Mediated Isothermal Locus-specific Expansion (SMILE) may be used. This method is illustrated in FIG. 3. Genomic DNA is digested with a restriction enzyme, such as Sau3a to generate double stranded fragments (301). A splint oligonucleotide (303) is used to bring the two ends of a single strand of a restriction fragment (305) together. The ends are then ligated using DNA ligase to form a circular molecule (307). In a preferred aspect the ligase is a thermostable DNA ligase such as Taq DNA ligase. The splint may be designed to bring the ends together so that they can be directly ligated or there may be a gap of one or more base between the ends that can be filled in, for example, by extension of the 3′ end with a polymerase or by ligation of a gap filling oligonucleotide to the ends of the fragment to fill the gap. Non-circular DNA molecules may then be degraded using exonucleases such as T7 ExoI, E coli Exo I, Rec J, lambda Exonuclease and Exo III (“Exo” is equivalent to exonuclease). The circular molecules can be amplified using random hexamers and phi29 DNA polymerase. The DNA may be used, for example, for SNP genotyping, DNA methylation analysis, or copy number analysis. In another embodiment the splint may be biotin-labeled and target may be enriched by affinity selection using streptavidin, for example, streptavidin (SA) coated beads. The targets are bound to the splints and the splints become bound to the beads through the interaction between the biotin on the splint and the SA on the bead. This enrichment may be followed by exonuclease digestion of linear molecules followed by amplification of the circular targets. Random hexamers and a strand displacing polymerase such as phi29 may be used for amplification of the circles.

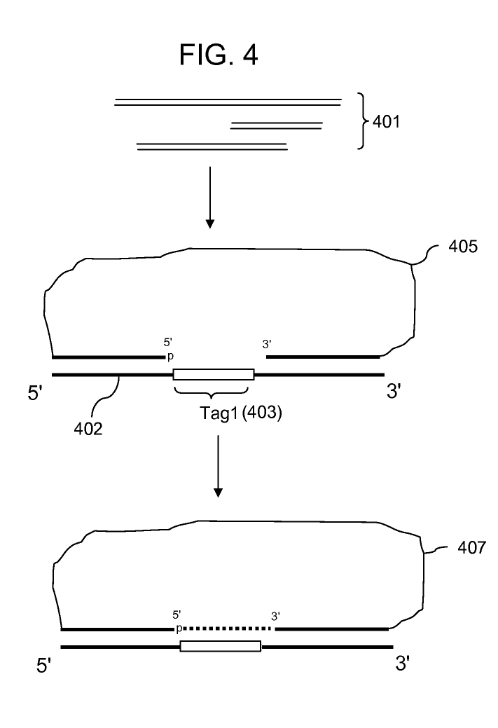

In another embodiment a tag sequence is introduced into the circle as shown schematically in FIG. 4. The genomic DNA is digested with a restriction enzyme such as Sau3a to generate fragments (401). Target fragment (405) is annealed to a splint DNA (402) that has target complementary regions flanking a tag sequence (403). The 3′ end of the fragment is extended with dNTPs and a DNA polymerase, preferably a polymerase that lacks strand displacing activity and 5′ exonuclease activity. A ligase such as Taq DNA ligase is used to seal the nick and form a closed circle. The circularized fragment (407) can be amplified by RCA using a locus specific primer or random primers and a DNA polymerase such as phi29 as discussed above. The amplification product can be detected by hybridization to an array of tag probes complementary to the tag sequence. Each splint may carry a different tag and the presence of absence of the tag in the amplification reaction can be detected using a hybridization assay to determine the presence or absence of the target fragment in the sample or the amount of the target fragment in the sample.

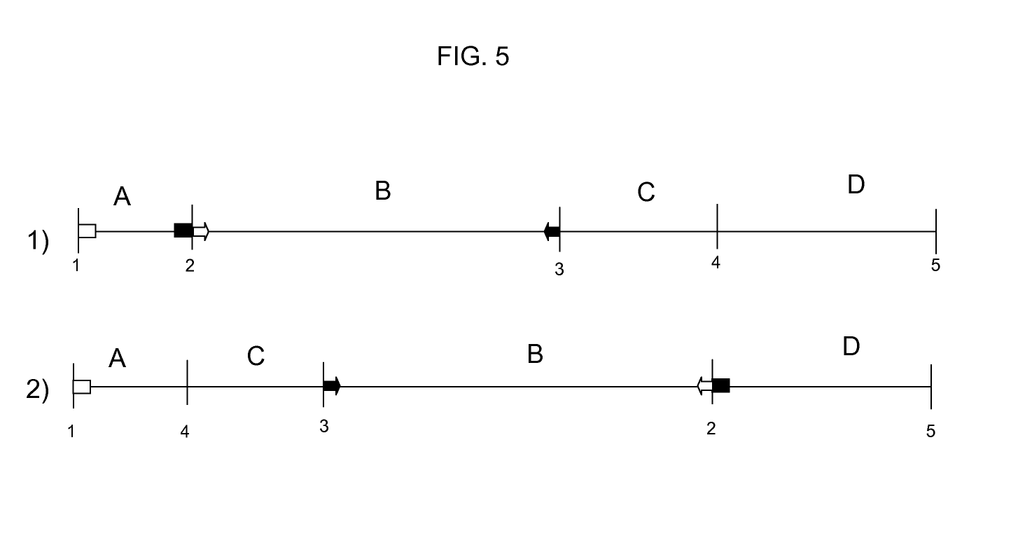

The methods of splint mediated amplification disclosed herein may be used for detection of inversions as shown in FIG. 5. Restriction enzyme cites are indicated by vertical lines and labeled 1-5. The sequences between the sites are labeled as A-D. The inversion shown involves segments B and C. In sequence 1) the order of the restriction sites is 1, 2, 3, 4, 5 and the order of the sequences is A, B, C and D. In sequence 2) the order of the restriction sites is 1, 4, 3, 2, 5 and the order of the sequences is A, C, B, and D. The splints are designed to bring together the ends of the restriction fragments so a splint designed to bring together 1 and 2 would circularize and allow for amplification of A in 1) but no sequences in 2). Since the regions targeted by the ½ splint are on separate restriction fragments in 2) that splint would not result in circularization or amplification of any fragment in 2). A splint for ⅔ would result in amplification of B in both 1) and 2). Splints for ¼ and ⅖ amplify sequences that are unique for inversion, no amplification in 1) and amplification of fragments A and D in 2).

Splints may be synthesized by multiplex synthesis methods. Large numbers of oligos may be synthesized in parallel using micro fluidic parallel array synthesis methods. Adaptor sequences may be included on either end of the oligo and used to amplify subsets or collections of the oligos. During the amplification process one of the primers that is used may include a selective entity such as biotin that can be used to separate one strand of the double stranded PCR product from the other to capture a collection of single stranded splints for use. In one aspect the double stranded PCR product may be captured and the non-biotinylated strand can be eluted off using, for example, NaOH. The eluate may be collected and used as splints.

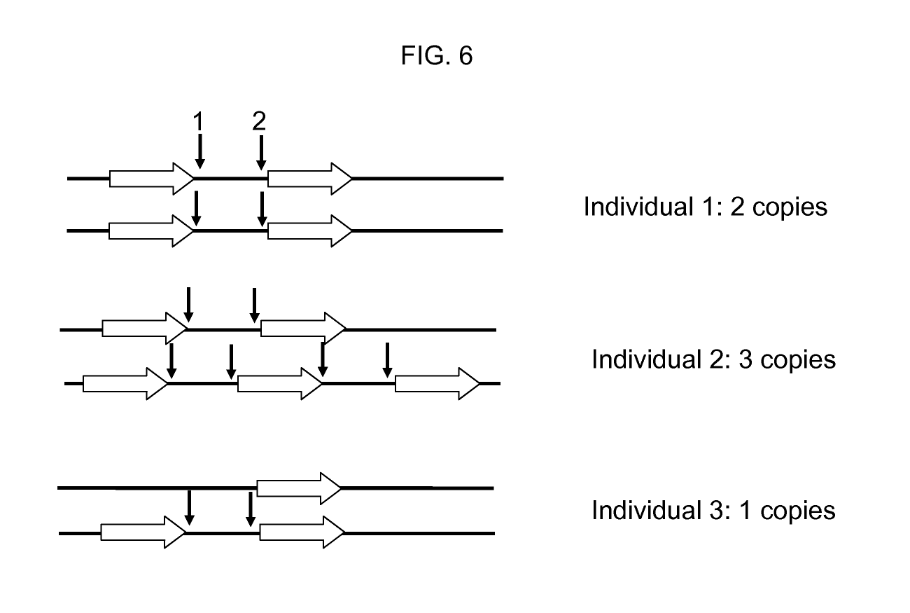

FIG. 6 illustrates how the splint mediated amplification method may be used for the detection of copy number polymorphisms (CNPs). The splint for restriction sites 1 and 2 amplifies the region between the two arrows. In individual 1 that region is present in 2 copies. Individual 2 has a duplication on one chromosome for a total of 3 copies of the region. Individual 3 has a deletion of the region in one chromosome for a total of 1 copy of the region. The copy number may be estimated by measuring the relative amount of a amplification product detected by a locus specific or tag specific probe.

In preferred aspects the methods are performed in a multiplex fashion for the simultaneous analysis of many different targets. For example, more than 100 to 1000, 1,000 to 10,000, 10,000 to 100,000 or more than 100,000 different targets may be amplified by the methods disclosed herein and analyzed. Analysis may be for example, for presence or absence of target sequences, to genotype polymorphisms (for example SNPs or CNPs) in a sample or for analysis of methylation status.

The methods disclosed herein are related to methods disclosed in other co-pending patent applications. Methods for isothermal locus specific amplification are disclosed in US Pat Pub 20070020639. Methods for genotyping with selective adaptor ligation are disclosed in US Pat Pub 20060292597. Methods for reducing the complexity of a genomic sample are disclosed in US Pat Pub 20060073511. Genotyping arrays are disclosed, for example, in US Pat Pub 20070065846 and 20070048756. Methods for adding common primers to the ends of target sequences for multiplex amplification are disclosed in US Pat Pub 20030096291. Methods for identifying DNA copy number changes are disclosed in US Pat Pub 20060134674 and 20050064476. Each of these disclosures is incorporated herein in its entirety for all purposes.

As shown in FIG. 2B isothermal amplification may be facilitated by nicking in the common priming strand near the 5′ end of one strand of the double stranded product and extending from the nick. The newly synthesized strand, which includes the primer and the first extension product, may then be cleaved to regenerate a nick. It may be by an endonuclease that recognizes an inosine base in the primer. In a preferred aspect, nicking occurs 3′ of the inosine base so that the modified base remains unaffected. The nicking generates a free 3′ OH within the primer that can be extended to generate a second extension product that displaces the first extension product. The nicking, extending and displacing steps are repeated at least once to obtain multiple copies of single-stranded DNA complementary to the template DNA sequence.

In a preferred embodiment, the DNA polymerase extends the 3′ end of the primer and contains 3′ to 5′ exonuclease activity. DNA polymerases that may be used include, for example, Klenow fragment, Bst polymerase, and phi29 polymerase. In some aspects Bst DNA polymerase is used. Bst DNA polymerase is thermal stable and reactions are preferably incubated at about 65° C., the enzyme is also active at lower temperature, for example, the enzyme retains 30%-45% of its activity at 50° C. In another preferred embodiment, phi29 DNA polymerase is used. Phi29 has an optimal temperature range of about 30° C.-37° C. If an initial denaturation step is being used, the enzymes are preferably added after denaturation. The denaturation step takes place at about 95° C. while the annealing step takes place at about 50° C. Bst DNA polymerase and phi29 DNA polymerase have strong strand displacement activity, so any products generated from the natural 3′ end of the original primer or from a prior nick will be displaced by new products made from the extending nick. In a preferred embodiment, the nicking, extending, and displacing steps are performed simultaneously in a single reaction, preferably under isothermal conditions. In many aspects the strand displacing polymerase and the nicking endonuclease are active under the same reaction conditions and within the same temperature range. Bst DNA Polymerase, and Endo V from E. coli, are active under similar buffer conditions, for example a buffer that consists of 20 mM Tris-acetate, 50 mM potassium acetate, 10 mM magnesium acetate and 1 mM DTT, pH 7.9 at 25° C. Compositions of other buffers that could be used include: 10 mM Bis-Tris-propane-HCl, 10 mM magnesium chloride and 1 mM DTT, pH 7.0 at 25° C.; 50 mM sodium chloride, 10 mM Tris-HCl, 10 mM magnesium chloride and 1 mM DTT, pH 7.9 at 25° C.; 100 mM NaCl, 50 mM Tris HCl, 10 mM magnesium chloride and 1 mM DTT, pH 7.9 at 25° C. In preferred aspects the polymerase extends the primer more than 10,000 bases, more than 100,000 bases or more than 1,000,000 bases. Ultra long extension may result in the use of a relatively small number of locus specific primers to generate amplification of one or more genomic regions of interest.

In a preferred embodiment, when the nicking site is inosine, the endonuclease is Endonuclease V (Endo V). Endo V will also cleave 3′ of an abasic site. Endo V is a repair enzyme found in E. coli that recognizes deoxyinosine, a deamination product of deoxyadenosine in DNA. Endo V, often called deoxyinosine 3′ endonuclease, recognizes DNA containing deoxyinosines (paired or not) on double-stranded DNA, single-stranded DNA with deoxyinosines and to a lesser degree other damages in DNA, for example, DNA containing abasic sites (ap) or urea, base mismatches, insertion/deletion mismatches, hairpin or unpaired loops, flaps and pseudo-Y structures. Endo V does not remove the deoxyinsoine or the damaged bases. Endo V cleaves the second and third phosphodiester bonds 3′ to the mismatch of deoxyinosine with a 95% efficiency for the second bond and a 5% efficiency for the third bond, leaving a nick with 3′-hydroxyl and 5′-phosphate. The optimal temperature range of E.coli Endo V is about 30° C. to 37° C. but the enzyme is active between 30° C. to 60° C. Endo V from E. coli is commercially available from, for example, New England Biolabs. Thermal stable Endo V is also commercially available, for example, Tma (Fermentas Life Sciences). The nick is made downstream of the inosine base leaving the inosine base 5′ of the nick, so the process can repeat itself many times. In preferred aspects a thermal stable strand displacing enzyme, for example, Bst DNA Polymerase is paired in a reaction with a thermal stable Endo V, for example, Tma. In another aspect, Phi29 is paired with EndoV. In preferred aspects, the endo V and the polymerase are active under the same buffer and reaction conditions, including temperature.

In another embodiment, inosine bases may be incorporated at low levels into the DNA polymerase product. For example, phi29 DNA polymerase can incorporate dITP bases opposite cytosine bases. By titrating in a small amount of dITP with dGTP, the inosine serves as a base along the growing product that can recognized by Endo V. These nicks will serve as new points of initiation for the DNA polymerase. This method should allow polymerization to extend farther from the original primer. The starting ratios of dITP to dGTP may be, for example, 1:10, 1:100, or 1:1,000.

In another aspect, the primer has one or more uracil bases or uracil is incorporated in the extension product. The extension product may be treated with uracil DNA glycosidase to generate an abasic site at a uracil and Endo V may be used to cleave 3′ of the abasic site to generate an extendable nick.

In many embodiments of the methods where circular fragments are to be amplified the amplification is by a strand displacing polymerase and random primers, for example, random hexamers. Kits for amplification using phi29 and random primers are commercially available, for example, GenomiPhi (Amersham) or REPLI-g (Qiagen). This material may be purified, fragmented, for example using a nuclease such as DNase I, and end-labeled with TdT and DLR and hybridized to an array, for example, a SNP genotyping array such as the Mapping 100K, 500K, SNP 5.0 and SNP 6.0 arrays from Affymetrix.

The fragmentation process produces DNA fragments within a certain range of length that can subsequently be labeled. The average size of fragments obtained is at least 10, 20, 30, 40, 50, 60, 70, 80, 100 or 200 nucleotides. Fragmentation of nucleic acids comprises breaking nucleic acid molecules into smaller fragments. Fragmentation of nucleic acid may be desirable to optimize the size of nucleic acid molecules for certain reactions and destroy their three dimensional structure. For example, fragmented nucleic acids may be used for more efficient hybridization of target DNA to nucleic acid probes than non-fragmented DNA. According to a preferred embodiment, before hybridization to a microarray, target nucleic acid should be fragmented to sizes ranging from about 50 to 200 bases long to improve target specificity and sensitivity.

Labeling may be performed before or after fragmentation using any suitable methods. The amplified fragments are labeled with a detectable label such as biotin and hybridized to an array of target specific probes, such as those available from Affymetrix under the brand name GENECHIP®. Labeling methods are well known in the art and are discussed in numerous references including those incorporated by reference.

In preferred aspects multiple copies of DNA generated by the disclosed methods are analyzed by hybridization to an array of probes. One of skill in the art would appreciate that the amplification products generated by the methods are suitable for use with many methods for analysis of nucleic acids. Many different array designs are available and are suitable for the practice of this invention. In some aspects the target is labeled and hybridized to an array where features of the array are at known or determinable locations. The feature is labeled by the interaction of the labeled target with the probe at the feature. In other embodiments the target is unlabeled and the probe on the array becomes labeled by an enzymatic process. For example, the probe may be extended using the hybridized target as a template. High density arrays may be used for a variety of applications, including, for example, gene expression analysis, genotyping and variant detection. Array based methods for monitoring gene expression are disclosed and discussed in detail in U.S. Pat. Nos. 5,800,992, 5,871,928, 5,925,525, 6,040,138 and PCT Application WO92/10588 (published on Jun. 25, 1992). Suitable arrays are available, for example, from Affymetrix, Inc. (Santa Clara, Calif.).

### EXAMPLES

### Example 1

### SMILE

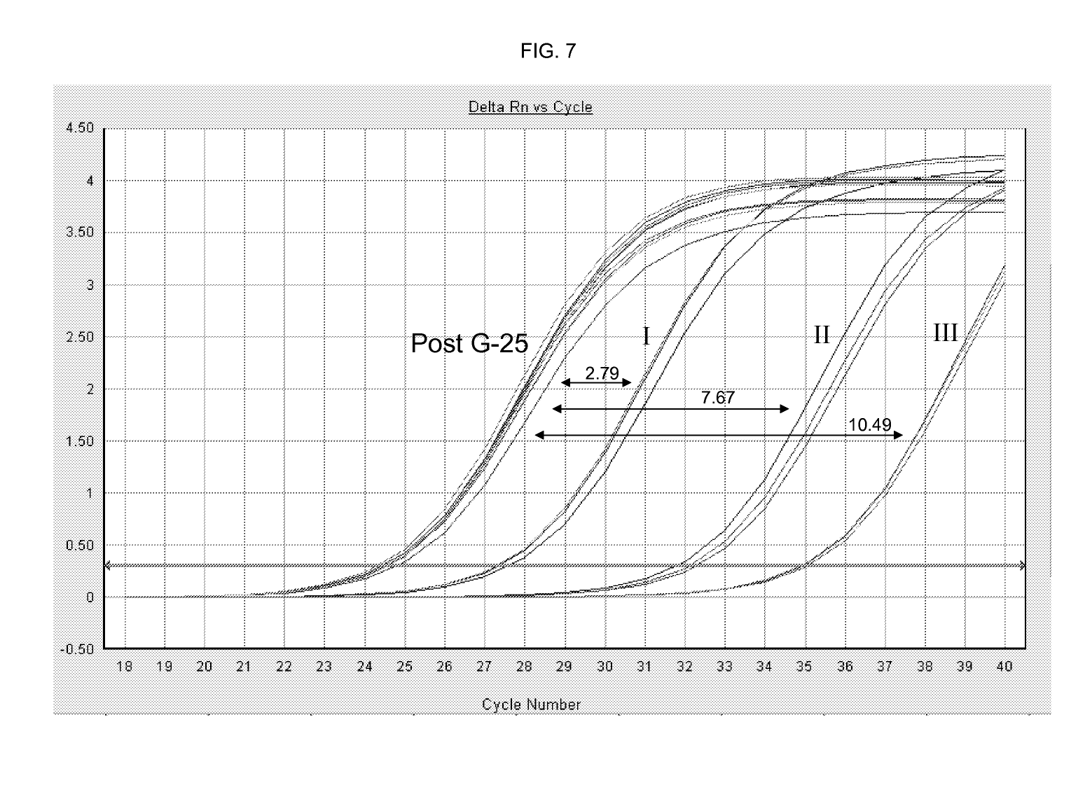

To test the amplification method a model Sau3a restriction fragment containing a control QPCR amplicon for HTR2a was circularized using a 24 base splint. Denature at 95° C. for 10 min. Set up 3 reactions: (I) Taq DNA ligase with splint, (II) splint with no Taq DNA ligase, and (III) Taq DNA ligase with no splint. Incubate at 50° C. for 12 hours. The splint is a 24 mer. Pass each rxn over G-25 column. Treat with Exo 1 and lambda Exo at 37° C. for 1 hr. Purify products on Qiagen column. Incubate with phi29 DNA polymerase with random hexamers. Use Sybr Green based QPCR (HTR2a) to assess protocol. FIG. 7 shows the results of the Sybr Green assay. As expected, the sample with ligase and the splint increases the QPCR signal (lower Ct value). The Ct values were as follows: rxn I was 14.6, rxn II was 0.7 and rxn III was 1.55. The difference between I and III corresponds to an enrichment of 216 or 65,536 fold enrichment of the restriction fragment. As a further confirmation the reactions were diluted 1:4000 and the HTR2a QPCR was repeated. Signal was observed only for rxn I as expected. As an additional control a QPCR was performed on the products for a locus unrelated to the splint (RNasesP). As expected all three reactions showed similar results for the unrelated PCR, in other words there was no amplification of the locus in rxn I as compared to II and III.

### Example 2

### Splint Titration

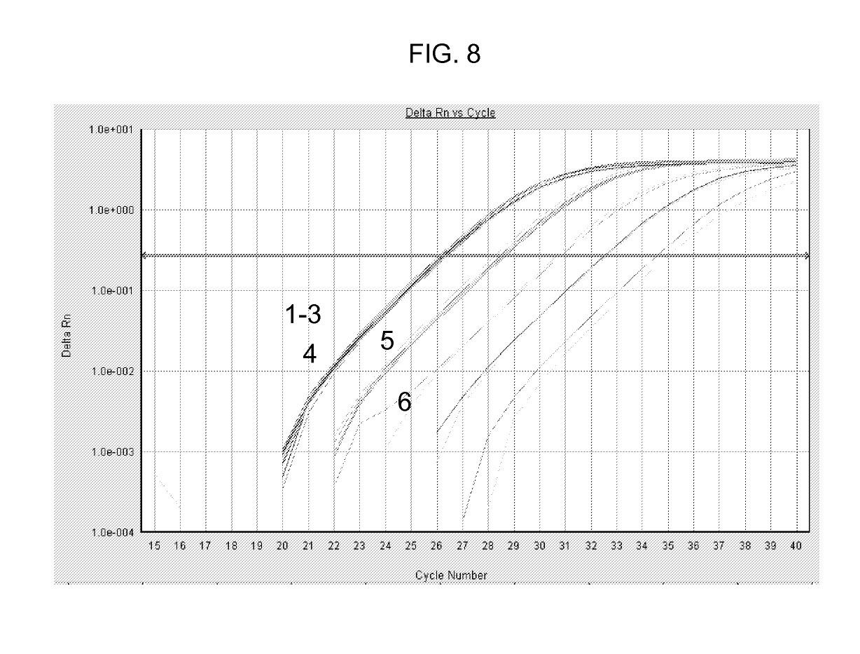

In another experiment using the same target and splint used in Example 1, different amounts of splint were tested as follows: 1.4 μM, 2.40 nM, 3.400 pM, 4.4 pM, 5.0.8 pM and 6. no splint. As shown in FIG. 8, decreasing amounts of splint resulted in decreased amounts of QPCR signal.

### Example 3

### Multiplex SMILE

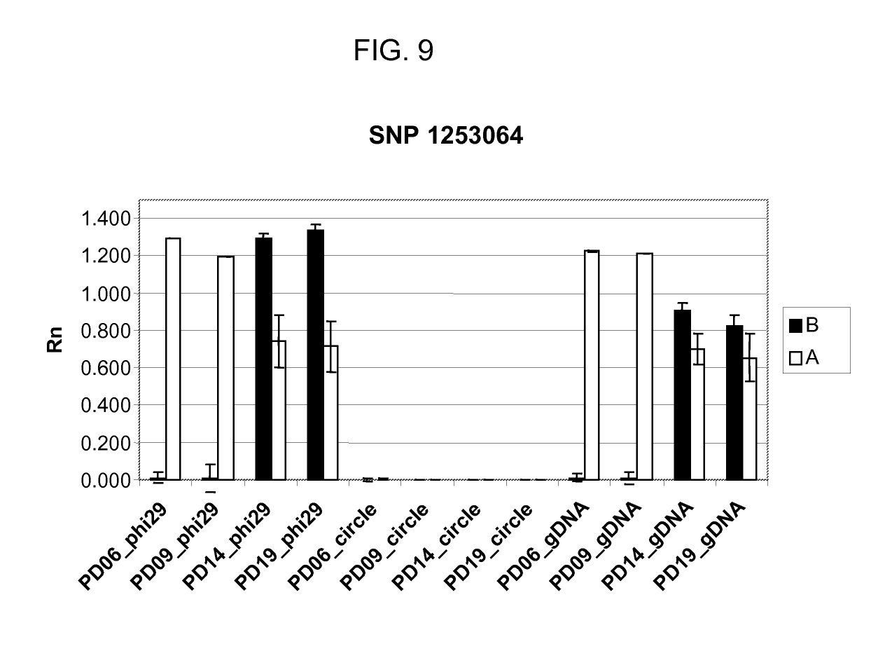

Splints were designed to target 9 Sau3a fragments. The fragments had the following lengths: 586, 573, 641, 2118, 1096, 973, 291, 783, and 1542 basepairs. Each of the target fragments contains a SNP and the amplification products were assayed using TaqMan genotyping assays to determine if the SNP could be accurately genotyped in the amplification product. The genomic DNA and the unamplified circles were also genotyped as controls. Each of 4 genomic DNA samples (PD06, PD09, PD14 and PD19) was amplified. Circles were prepared as above and enriched using Exo treatment. The enriched circles were used as template for phi29/random hexamers amplification. All of the 9 fragments were detected in each of the 4 samples and the TaqMan genotyping analysis agreed with the known genotypes of the samples. As shown for one of the SNPs in FIG. 9 accurate genotypes were obtained from the TaqMan assays using the amplification product of the circles (labeled “phi29”) and from the genomic DNA sample “gDNA” but not from the unamplified circles “circle”. Known genotypes of the samples for the SNP assayed in FIG. 9 are as follows: PD06 is AA, PD09 is AA, PD14 is AB and PD19 is AB. Genotypes were tested for 7 of the 9 SNPs and in all cases the phi29 amplified product gave the accurate genotype calls.

### Conclusion

It is to be understood that the above description is intended to be illustrative and not restrictive. Many variations of the invention will be apparent to those of skill in the art upon reviewing the above description. The scope of the invention should be determined with reference to the appended claims, along with the full scope of equivalents to which such claims are entitled. All cited references, including patent and non-patent literature, are incorporated herewith by reference in their entireties for all purposes.

What is claimed is:

1. A method for amplifying a plurality of target sequences from a nucleic acid sample and analyzing the amplified target sequences, said method comprising:
(a) fragmenting the nucleic acid sample with at least one restriction enzyme to generate fragments with known sequences at the 5′ fragment end and the 3′ fragment end, wherein at least some of the fragments are target fragments;
(b) mixing the fragments obtained in (a) with a plurality of target specific splint oligonucleotides, wherein each splint oligonucleotide comprises a first sequence that is at least 10 bases in length and is perfectly complementary to the at least 10 bases at the 5′ end of a corresponding target fragment, and a second sequence that is at least 10 bases in length and is perfectly complementary to the at least 10 bases at and including the 3′ end of said corresponding target fragment, and wherein said first sequence is 5′ of said second sequence in said splint oligonucleotide, wherein target specific splint oligonucleotides hybridize to corresponding target fragments so that the 5′ and 3′ ends of the hybridized target fragments are brought into proximity of one another;
(c) ligating the ends of the hybridized target fragments to obtain circularized target fragments;
(d) separating the circularized target fragments from splint oligonucleotides and uncircularized fragments;
(e) amplifying the circular target fragments to obtain amplified target sequences; and
(f) analyzing the amplified target sequences using an array comprising a plurality of oligonucleotide probes present at known or determinable locations in the array.

2. The method of claim 1, wherein prior to step (f) amplified target sequences are fragmented to obtain amplified target fragments and the amplified target fragments are labeled with a detectable label to obtain labeled fragments and wherein said step of analyzing comprises hybridizing the labeled fragments to said array.

3. The method of claim 1 wherein said plurality of target sequences comprises between 100 and 100,000 different target sequences.

4. The method of claim 1 wherein said plurality of target sequences comprises between 1,000,000 and 3,000,000 different target sequences.

5. The method of claim 1 wherein step (d) comprises digesting splint oligonucleotides and uncircularized fragments using an exonuclease.

6. The method of claim 1 wherein step (d) comprises hybridizing a plurality of target specific oligonucleotides to the circles, wherein said target specific oligonucleotides are biotinylated and separating the target circles from non-target sequence using streptavidin affinity matrix.

7. The method of claim 1 wherein said amplifying comprises incubation of the circular target fragments with random primers and a strand displacing DNA polymerase

8. The method of claim 1 wherein said step of analyzing is to determine the genotype of polymorphisms in said target sequences in said nucleic acid sample.

9. The method of claim 1 wherein said step of analyzing is to determine the methylation status of one or more cytosines in said target sequences in said nucleic acid smaple.

10. The method of claim 1 wherein said step of analyzing is to determine the presence or absence of specific target sequences in said nucleic acid sample.

11. The method of claim 1 wherein each of said target specific splint oligonucleotides comprises a different tag sequence between said first sequence and said second sequence and wherein the 3′ end of the target fragment is extended along the splint oligonucleotide using a DNA polymerase to incorporate the complement of the tag sequence into the fragment before ligating the ends to form a circular fragment comprising a tag sequence complement and wherein said array is an array of tag probes.

12. A method for amplifying and analyzing a plurality of target sequences from a nucleic acid sample, said method comprising:
(a) fragmenting the nucleic acid sample with a restriction enzyme to obtain fragments with known sequences at the 5′ and 3′ ends of the fragments, wherein said fragments comprise a plurality of target fragments comprising target sequences;
(b) mixing the fragments obtained in (a) with a plurality of target specific splint oligonucleotides, wherein each splint oligonucleotide comprises a first target complementary sequence that is at least 10 bases in length and is perfectly complementary to the at least 10 bases at the 3′ end of a corresponding target fragment, and a second target complementary sequence that is at least 10 bases in length and is perfectly complementary to the at least 10 bases at and including the 5′ end of said corresponding target fragment, and wherein said first sequence is 5′ of said second sequence in said splint oligonucleotide, wherein target specific splint oligonucleotides further comprises a first common priming sequence at the 5′ end and a second common priming sequence at the 3′ end;
(c) adding first and second primers to the mixture wherein said first primer is complementary to said first common priming sequence and said second primer is complementary to said second common priming sequence and wherein said first and second primers hybridize to said splint oligonucleotides so the first primer is adjacent to the 3′ end of the target fragment and the second primer is adjacent to the 5′ end of the target fragment;
(d) ligating the first primer to the 3′ end of the target fragment and the second primer to the 5′ end of the target fragment to obtain ligated target fragments comprising a first common priming site at the 3′ end and a second common priming sites at the 5′ end;
(e) after said ligating step (d) fragmenting said splint oligonucleotides;
(f) amplifying the ligated target fragments from (d) to obtain amplified target fragments; and
(g) analyzing the amplified target fragments by a method comprising hybridization to an array comprising a plurality of oligonucleotide probes present at known or determinable locations in the array.

13. The method of claim 13 wherein each splint oligonucleotide further comprises a target fragment specific tag sequences located between the first target complementary sequence and the first common priming sequence or between the second target complementary sequence and the second common priming sequence and wherein tag complement oligonucleotides that are complementary to the tag sequences in the splint oligonucleotides are added at step (c) and ligated to the target fragments in step (d) so that the tag complements are adjacent to one of the common priming sequence in the ligated target fragments and wherein the array is a tag array.

14. The method of claim 12 wherein the second primer comprises a nicking position and wherein said amplifying comprises:
(a) making the ligated target fragments double stranded;
(b) nicking the nicking position;
(c) extending from the nick using a strand displacing DNA polymerase; and
(d) repeating steps (b) and (c).

15. The method of claim 13 wherein said nicking is by cleavage with a nicking restriction enzyme.

16. The method according to claim 13, wherein said second primer is between 15 and 50 bases in length.

17. The method of claim 13, wherein said DNA polymerase is active at a temperature between 30° C. and 80° C.

18. The method according to claim 13, wherein the DNA polymerase is Bst DNA polymerase and is active between 50° C. to 65° C.

19. The method according to claim 13, wherein said nicking is by Endo V.

20. The method of claim 19, wherein said Endo V is a thermal stable version.

21. The method of claim 12 wherein the splint oligonucleotides comprise one or more uracil bases and wherein the splint oligonucleotides are cleaved by uracil DNA glycosidase treatment, wherein the uracil is converted to an abasic site by uracil DNA glycosidase and the abasic sites are cleaved.
